(19) United States
(12) Patent Application Publication
(10) Pub. No.: US 2025/0163651 A1
(43) Pub. Date: May 22, 2025

(54) METHOD FOR PRODUCING A FILTERING MATERIAL

(71) Applicant: BIOSORBE AB, Kristinehamn (SE)

(72) Inventors: Johan BENNARSTEN, SALTSJÖ-BOO (SE); Björn SJÖSTRAND, KARLSTAD (SE); Annelie BROLINSON, KARLSTAD (SE); Lars-Erik SJÖGREN, DANDERYD (SE)

(21) Appl. No.: 18/841,028

(22) PCT Filed: Feb. 16, 2023
(86) PCT No.: PCT/SE2023/050138

§ 371 Date: Aug. 23, 2024

(30) Foreign Application Priority Data
Feb. 25, 2022 (SE) 2250261-1

(51) Int. Cl. D21H 27/08; B01D 39/16; B01D 39/18; D21F 11/14; D21H 11/04; D21H 17/00; D21H 17/34; D21H 17/66; D21H 23/04; D21J 5/00

(52) U.S. Cl. CPC D21H 27/08; B01D 39/163; B01D 39/18; D21F 11/14; D21H 11/04; D21H 17/34; D21H 17/66; D21H 17/74; D21H 23/04; D21J 5/00; B01D 2239/0241; B01D 2239/0266; B01D 2239/0428; B01D 2239/10

(57) ABSTRACT

A method for producing a filtering material comprising a cellulosic material and a positively charged polyelectrolyte comprising polyvinylamine (PVAm), wherein said method comprises at least the steps of: —providing a stock comprising said cellulosic material comprising cellulose fibers; —adding said polyvinylamine to said stock such that a concentration of PVAm in the stock is in an interval of 0.5-2.0 wt-% of a dry weight of cellulose fibers in polyelectrolyte to said stock, and —allowing said cellulosic material to adsorb said polyvinylamine.

### FIELD OF THE INVENTION

The present invention relates to a method for producing a filtering material comprising cellulose fibers.

The present invention also relates to a filtering material manufactured by the inventive method.

### BACKGROUND INFORMATION

In recent years, the need for air filtration and purification has become more recognized, both indoor and outdoor.

The concerns of energy efficiency and indoor air quality have led to numerous air filtration products, such as HEPA filters and the like, that purport to remove small particles, allergens, and even microorganisms from the air.

Many of these purification techniques and practices are costly, energy inefficient and/or require significant technical know-how and sophistication. Traditional means of reducing these complications require extensive processing or specially designed apparatus. Unfortunately, development of low cost techniques do not adequately address the removal of harmful chemical and biological contaminates, such as, bacteria and viruses. For example, simple point-of-use purification devices, such as filters attached to in-house air supply conduits or portable face masks, cannot sufficiently remove oil mist, particles from fires, bacteria and viruses unless relatively costly membrane technology or strong chemical oxidizers, such as halogens or reactive oxygen species, are utilized.

It is well known to use granular, particulate, or fibers of natural or synthetic materials for filtration. These materials are commonly used singularly and in mixtures. In some cases a material which immobilizes the individual particles or fibers together, referred to as a binder, is used. Techniques for generating porous blocks of carbon using a polymer binder is described in prior art.

Accordingly, there remains a need in the art of filtration for an uncomplicated, safe, inexpensive filtering material as a starting material for production of different kinds of filters. There is also a need of a filtering materials made of natural raw materials that are biodegradable and originate from renewable sources.

### SUMMARY OF THE INVENTION

It is an object of the present invention to obviate at least some of the disadvantages in the prior art and to provide a method for producing a filtering material according to claim 1.

In a first aspect of the invention, a method for producing a filtering material comprising a cellulosic material and a positively charged polyelectrolyte comprising polyvinylamine (PVAm), wherein said method comprises at least the steps of:
providing a stock comprising said cellulosic material comprising cellulose fibers;
adding said polyvinylamine to said stock such that a concentration of PVAm in the stock is in an interval of 0.5-2.0 wt-% of a dry weight of cellulose fibers in the stock, and
allowing said cellulosic material to adsorb said polyvinylamine.

The inventive method is a wet-forming method wherein said stock is an aqueous suspension comprising the cellulosic material.

In one embodiment said method preferably further comprises the steps of:
Forming a wet web of the stock comprising cellulosic material with adsorbed polyelectrolyte;
Dewatering said wet web by pressing, and
Drying said wet web.

In one embodiment said method for producing a filtering material according to claim 1, further comprises a wet-molding procedure comprising the following steps:
Providing a three-dimensionally (3D) shaped forming tool comprising a forming portion;
Bringing said 3D shaped forming tool comprising a forming portion into contact with the stock;
Apply means of vacuum suction such that the stock is drawn onto the forming portion and a 3D filtering material of desired thickness is being formed on said forming portion;
Removing said 3D filtering material from said forming portion, and
Dewatering of said 3D filtering material by pressing and/or drying, whereby a molded 3D filtering material is formed.

A filtering material with highly improved air permeance, which does not adsorb humidity due to its high degree of hydrophobicity and as such has a very good filtering effect of hydrophobic substances has thereby been produced by the inventive method.

The dry web of the filtering material may reeled to rolls of filtering material and in a later stage be cut to filtering materials of appropriate sizes, i.e. filtering material sheets, for use in e.g. ventilation systems and fan systems, or a starting material for producing e.g. face masks and mouth guard masks.

The molded 3D filtering materials preferably have shapes complementary to systems or devices to be used with, or adapted to, better fit to faces of persons.

Polyelectrolytes are polymers whose repeating units bear an electrolyte group. Polycations and polyanions are polyelectrolytes. These groups dissociate in aqueous solutions (water), making the polymers charged. Polyelectrolyte properties are thus similar to both electrolytes (salts) and polymers (high molecular weight compounds) and are sometimes called polysalts. Like salts, their solutions are electrically conductive.

The polyelectrolyte added to the stock is a positively charged polyelectrolyte. Said positively charged polyelectrolyte adsorbs to the surface of the cellulosic material, probably to the surface of the negatively charged fibers of the cellulosic material. A positively charged polyelectrolyte adsorbed to the fibers of the cellulosic material affects the negative charge of the cellulose fibers by modifying the negative charge of the fibers to be less negative or change the fiber charge to a net zero charge of the cellulosic material. For highly positively charged polyelectrolytes adsorbed to the cellulosic material the net charge of the cellulosic material may even be positive.

The positively charged polyelectrolyte is preferably selected from the group comprising polyvinylamine (PVAm), polyacrylamide, chitosan, cationic gelatin, polydiallyldimethylammonium chloride (poly DADMAC), polyallylamine, and/or polyethylenamine.

In one embodiment, the polyelectrolyte is preferably polyvinylamine (PVAm) including unmodified PVAm or PVAm modified with straight or branched and optionally substituted alkyl chains. PVAm has a very high content of primary amine functional groups and is one of the technical polymers having the highest charge density.

It may be preferred that PVAm is unmodified.

Said PVAm is added to the stock such that the concentration of PVAm in the stock is greater than 0.01 wt-% PVAm of a dry weight of cellulose fibers comprised in the stock.

Preferably, the concentration of PVAm in the stock is equal to or greater than 0.1 wt-% PVAm, and more preferred equal to or greater than 0.5 wt-%.

Preferably, the concentration of PVAm in the stock is 0.5-2.0 wt-% of a dry weight of cellulose fibers comprised in the stock.

In one embodiment the method comprises a step of adjusting pH of the stock to be in the interval of pH 7 to pH 11; preferably in the interval of pH 8 to pH 10.5, and more preferred in the interval of pH 9 to pH 10.

In one embodiment the method comprises a step of adding NaCl to the stock, and to a concentration of 0.1-1.2 wt-% NaCl of a of weight of cellulose fibers comprised in the stock, preferably a concentration of 0.2-1.0, and more preferred a concentration of 0.3-0.8 wt-% NaCl per weight of cellulose fibers.

Electrostatic repulsion within the polyelectrolyte chain and between different parts of the polyelectrolyte chain may be effectively reduced or screened upon salt addition to the polyelectrolyte solution, which in turn makes the polyelectrolyte chain less stiff so that it can coil up. In the same manner, the charges between adsorbed polyelectrolytes are screened as well, and the amount adsorbed to the surface can hence in practical situations be increased when salt is added.

In one embodiment of the inventive method, the steps of the method take place in the following order: NaCl is added to said stock. The addition of NaCl is followed by the step of adjusting pH. After having adjusted the pH of the stock, the step of adding a polyelectrolyte to the stock is performed.

In one embodiment, said cellulosic material preferably comprises High Yield Pulps (HYP) where single cellulose fibers are separated from the wood raw material, defibrated, as a result of mechanical treatments of chips in disc refiners or of logs in wood grinders after softening of the wood lignin at enhanced temperature and/or with chemical pretreatments, such as mechanical pulp, refiner mechanical pulp (RMP), thermomechanical pulp (TMP), chemi-thermomechanical pulp (CTMP), defibrated fiber-material, high temperature chemi-thermomechanical pulp (HTCTMP), chemimechanical pulp (CMP), stone groundwood pulp (SGW) and pressure groundwood pulp (PGW) or a mixture thereof. The wood yield in these types of pulping processes is high, typically over 90%.

In one embodiment, the polyelectrolyte is preferably PVAm and said cellulosic material preferably comprises HYP, preferably CTMP, and possibly mixed with other kinds of HYPs. The produced filtering material has preferably a dry weight in an interval of 10-240 gsm.

In one embodiment, said polyelectrolyte is preferably PVAm and said cellulosic material is preferably a kraft pulp, sulphate pulp, sulphite pulp, recycled paper and board, broke, nanopulp, dissolving pulp, deinked pulp (DIP), or regenerated fibers or mixtures thereof.

In one embodiment, said polyelectrolyte is preferably PVAm and said cellulosic material preferably comprises kraft pulp and the produced filtering material preferably has a dry weight in an interval of 10-240 gsm.

In one embodiment, said polyelectrolyte is preferably PVAm and said cellulosic material is preferably non-wood pulps, e.g. straw pulps, hemp pulps, bagasse pulps etc.

The present invention is also directed to a filtering material comprising a cellulosic material and a positively charged polyelectrolyte comprising polyvinylamine (PVAm), wherein said cellulosic material comprises cellulose fibers and wherein said positively charged polyelectrolyte comprising polyvinylamine (PVAm) is adsorbed to said cellulose fibers.

The filtering material comprising cellulosic material with modified, less negative, charge has the advantage of providing a higher air permeability, i.e. a lower air resistance. This means that lower energy amounts are required to press/suck/push air through the filtering material as compared to conventional filtering materials.

The filtering material has improved hydrophobicity thanks to the modification of the fibers to be less negatively charged, or even uncharged. A hydrophobic fiber structure is preferred because a hydrophobic filtering material will not adsorb water and get wet while the adsorption capacity of hydrophobic substances such as hydrocarbons, e.g. grease, oils, oil mists, fats, non-polar particles, and carbon compounds, is highly improved.

Furthermore, the filtering material has improved lipophilicity thanks to the modification to less negative charges of the fibers. The filtering material will have an improved absorption capacity for lipids and lipid particles.

It has also surprisingly been found that fiber structures are more easily dewatered if the negative charge of the fibers are modified to be less negative. A more easily dewatered fiber structure means that less energy is required to dewater said fiber structure during production of the filtering material.

For positively charged polyelectrolytes, bacteria and/or viruses are captured and bound to the filtering material, probably due to the fact that the positively charged polymer adsorbed to the cellulosic material attract the negatively charged bacteria and/or viruses.

Said filtering material is preferably a filtering material web, a filtering sheet material, a molded three-dimensional filtering material, a foam filtering material, or a mixture thereof. The filtering material web may easily be cut to appropriate sizes and shapes to fit into any ventilation device or to be converted to face masks or mouth guard masks.

In one embodiment, the polyelectrolyte is preferably PVAm and said cellulosic material preferably comprises HYP, preferably CTMP, and possibly mixed with other kinds of HYPs. The produced filtering material has preferably a dry weight in an interval of 10-240 gsm.

The filtering material may for instance be used as ventilation filters or air filters in fan systems. The filtering material may also be used in face masks and mouth guard masks.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

The invention will be described in more detail with reference to the enclosed figures, in which:

FIG. 1 shows drainage results for CTMP and kraft pulps, with and without 1 ml/gram fiber of PVAm;

FIG. 2 shows WRV results for CTMP and kraft pulps, with and without 1 ml/gram fiber of PVAm;

FIG. 3 shows moisture ratio (g/) and vacuum dewatering dwell time (ms) for CTMP 20 and 100 g/m², with and without 1 ml/gram fiber of PVAm;

FIG. 4 shows moisture ratio (g/) and vacuum dewatering dwell time (ms) for kraft pulp 20 and 100 g/m², with and without 1 ml/gram fiber of PVAm;

FIG. 5 shows force-stress curves for 60 g/m² CTMP with and without addition of 1 ml/gram fiber of PVAm;

FIG. 6 shows force-stress curves for 200 g/m² CTMP with and without addition of 1 ml/gram fiber of PVAm (washed and unwashed CTMP);

FIG. 7 shows force-stress curves for 200 g/m² kraft pulp with and without addition of 1 ml/gram fiber of PVAm;

FIG. 8 shows air permeance according to Bendtsen with 0.7 kPa instead of 1.47 kPa is shown, for single and double sheets of 200 g/m² CTMP with and without 1 ml/gram fiber of PVAm (washed and unwashed CTMP), and

FIG. 9 shows air permeance according to Bendtsen with 0.7 kPa instead of 1.47 kPa is shown, for single and double sheets of 200 g/m² kraft pulp with and without 1 ml/gram fiber of PVAm.

### DETAILED AND EXEMPLIFYING DESCRIPTION OF THE INVENTION

Before the invention is disclosed and described in detail, it is to be understood that unless clearly indicated, all percentages mentioned are calculated by weight. The term “about” as used in connection with a numerical value throughout the description and the claims denotes an interval of accuracy, familiar and acceptable to a person skilled in the art. Said interval is ±10%.

Cellulosic material denotes in this context a fibrous material comprising cellulose fibers. The cellulosic material may be in a dry or a wet condition. In dry form the cellulosic material has a fibrous structure. The cellulosic material may e.g. be diluted in an aqueous solution forming an aqueous pulp suspension termed stock. The cellulosic material may also be a wet or dry paper web or piecemeal of paper. Different kinds of cellulosic materials are exemplified below.

A stock denotes an aqueous pulp solution, a suspension, comprising cellulosic material; i.e. comprising cellulose fibers.

The following detailed description, and the examples contained therein, are provided for the purpose of describing and illustrating certain embodiments of the invention only and are not intended to limit the scope of the invention in any way.

### Experimental

### Fibers

Chemi-thermomechanical pulp (CTMP) fibers from Norway spruce (Picea abies), hereinafter referred to as CTMP fibers, were supplied by Rottneros AB (Sunne, Sweden). The CTMP fibers have a yield of 93-95% according to the supplier with a lignin content of 20-25%. The fines content measured by an on-line Pulpeye was 35%, with a standard deviation of 4.5%. pH of the CTMP was pH 7.

Bleached chemical softwood pulp fibers mixed from Norway spruce and Scots pine (Pinus sylvestris), hereinafter referred to as kraft fibers, were supplied by Stora Enso AB (Skoghall, Sweden). The kraft fibers were refined in the mill. pH of the kraft pulp was pH 8.4.

### Chemicals

Polyvinylamine (PVAm) was supplied by BASF SE (Ludwigshafen, Germany). The average molecular weight of the PVAm is 340,000 g/mol.

CTMP fibers and kraft pulps were prepared into 0.2% w/w with and without PVAm. Starting pH of the CTMP stock and kraft pulp stock was pH 7 and pH 8.4, respectively, before addition of PVAm. The solutions with PVAm were prepared according to the following procedure. 5.7 ml of 2M NaCl was added per gram dry pulp. pH was adjusted to >9.5. 1 ml/gram fiber of PVAm (10 g/l) was then added to the solutions.

### Fiber Potential Analysis

The fiber charge of the cellulosic materials with and without PVAm were analyzed with respect to Zeta potential. A cellulosic material without addition of PVAm was compared with a cellulosic material with addition of PVAm. The cellulosic materials analyzed were CTMP and kraft pulp. 6.5 g of cellulosic material was dissolved in 1 litre of water. The Zeta potential of the fiber suspension was measured twice in a Fiber Potential Analyzer. After the measurements, 0.1 wt-% NaCl per weight of cellulose fibers was added, followed by adjustment of pH to 9.6 and addition of 6.5 ml of PVAm (10 g/l), i.e. 1 wt-% PVAm per dry weight of cellulose fibers. The suspension was mixed, was left to stand for 10 minutes followed by thorough rinsing three times with water to ensure that no free PVAm remained in the suspension. The Zeta potential of the suspension comprising PVAm was measured twice in a Fiber Potential Analyzer.

One of the CTMP solutions with PVAm was semi-washed where approximately 40% of the total volume (6 of 16 liters) of the non-pulp phase in the solution was exchanged for fresh water without added chemicals. The PVAm already attached to fiber surfaces was assumed unaffected by the washing, it more likely only affected the ratio of chemicals in the water.

### Dewatering, Tensile and Air Permeance Testing

Dewatering of the different pulps was examined by measuring dewatering resistance (° SR), water retention value (g/g) and vacuum dewatering in a custom-built laboratory vacuum suction box with a commercial forming fabric, type SSB with a permeability of 325 cfm. Prior to the vacuum dewatering isotropic sheets are formed in a hand sheet former with thorough agitation of the stock to ensure consistent formation. The apparatus used in the present study is as described by Granevald, R., Nilsson, L. S., & Stenström, S. in the article “Impact of different forming fabric parameters on sheet solids content during vacuum dewatering”, Nordic Pulp & Paper Research Journal (2004), 19(4), p. 428-433, with the exception that a plate with a single 5 mm opening was used. The vacuum level set at −40 kPa, basis weights on the sheets 20 and 100 g/m², and dwell times of 0, 1, 2.5, 5, 10, 20 ms. After each test, the dryness was measured according to ISO 638:2008.

Sheets were also formed in a standardized sheet former, plane pressed and restrained dried at 60 and 200 g/m². The sheet former includes agitation of the stock to achieve consistent formation. The sheets were dried in a standardized climate according to ISO 187:1990, and all tensile and air permeance tests were performed there as well. The 200 g/m² sheets were subjected to air permeance testing according to ISO 5636-3:2013. The air permeance testing was adjusted with a lower pressure than the standard, however, since the sheets with PVAm were too open in the fiber formation to work with original settings. The air permeance measurements in this study were performed with 0.7 kPa pressure in the machine instead 1.47 kPa. The sheets, both 60 and 200 g/m², were subjected to tensile testing according to ISO 1924-3:2008.

### Results and Discussion

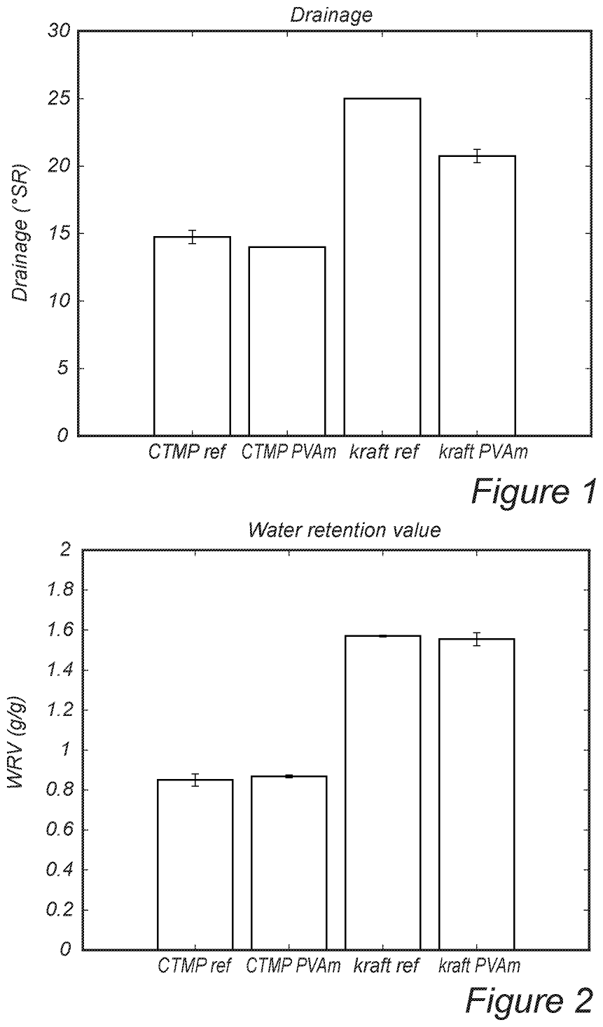

Drainage resistance (° SR) and water retention value (WRV) results for the pulps were tested are shown in FIG. 1 and FIG. 2. Examining the different pulps in the study, drainage according to Schopper-Riegler simulates early dewatering when water flows between fibers in the early stages of forming, and water retention value simulates later dewatering around high vacuum suction boxes or wet pressing with substantially higher initial dryness. Drainage and water retention results (FIGS. 1-2) indicated that addition of PVAm mainly affect the early dewatering, presumably by preventing the healing mechanisms and blocking of flow channels. The later dewatering according to the WRV results is barely affected by addition of PVAm under these conditions, this could be explained by the fact that PVAm additions does not affect the swelling of the fibers, but rather the flow behaviour in lower consistency solutions. No evidence is provided regarding swelling of fibers though.

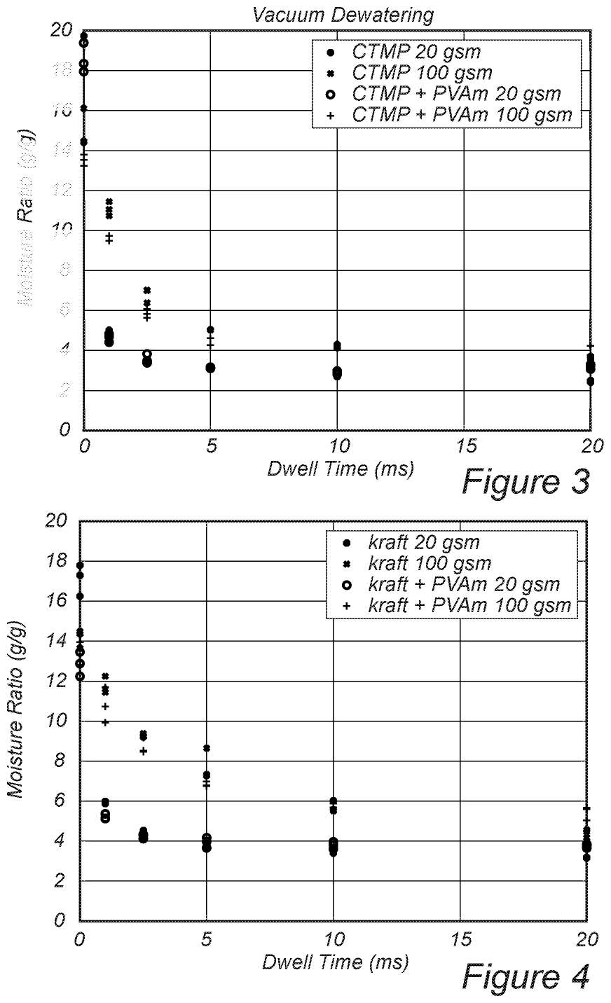

Dewatering results are expressed as development in moisture ratio (g/g) with vacuum dwell time (ms). These are shown in FIGS. 3-4. The dewatering behaviour measured by the laboratory scale vacuum dewatering equipment (FIGS. 3-4) also indicates that the early stages of dewatering are most influenced by PVAm additions. This is explained by the same mechanisms of healing and flow channel blocking as for drainage (° SR). At vacuum dwell times 0-5 ms significant differences are observed in dewatering, where additions of PVAm are more effectively dewatered than corresponding reference pulps. The effect is of course greater when the dewatering resistance is greater, when comparing 20 to 100 g/m² sheets. CTMP pulps have higher improvement in dewatering rates than kraft pulps with additions of PVAm.

At longer dwell times (10-20 ms) the addition of PVAm results in higher dewatering times, this is explained interaction between added chemicals and forming fabrics. At the end of the test series the forming fabrics were considerably less permeable which naturally resulted in slower dewatering. This is not making the reasoning behind dewatering mechanisms contradictory, but it is an important observation. When implementing the additions of PVAm in this fashion on an industrial scale, the forming fabrics cannot be sealed by the chemicals. The sealing behaviour must be prevented.

This study did not include such an investigation, but the problem may possibly be solved by an extra washing step after addition of chemicals. Furthermore, the poor formation will lead to less efficient vacuum dewatering where air will flow easily thorough the patches with less fibers and leaving more water in the more flocculated areas.

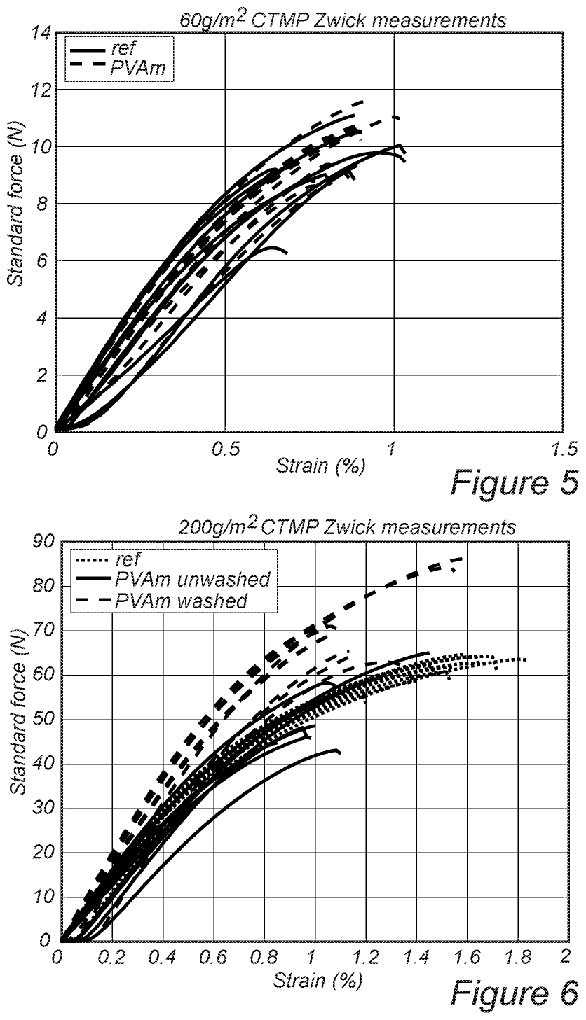

Strength measurements for sheets of kraft and CTMP pulp with and without PVAm are shown in the form of stress-strain curves in FIGS. 5-7, where FIG. 5 shows force-stress curves for 60 g/m² CTMP with and without addition of 1 ml/gram fiber of PVAm, with ten replicates according to standard (ISO 1924-3:2008), FIG. 6 shows force-stress curves for 200 g/m² CTMP with and without addition of 1 ml PVAm/gram fiber, with ten replicates according to standard (ISO 1924-3:2008). The pulps with added PVAm were both washed and unwashed as described above. FIG. 7 shows force-stress curves for 200 g/m² kraft pulp with and without addition of 1 ml/gram fiber of PVAm, with ten replicates according to standard (ISO 1924-3:2008).

When looking at the results from tensile testing of the different sheets, no significant differences can be found between references and PVAm additions (FIGS. 3-4) even though PVAm is normally considered to be a dry-strength agent. This is explained by visible worse formation of sheets with PVAm, which is also supported by the high variance of tensile results for the 200 g/m² PVAm CTMP sheets (FIG. 3). The benefits in strength properties gained by adding PVAm is evened out by the decrease in formation. One of the pulps were washed prior to forming and those did actually have significantly higher tensile strength (FIG. 3). Higher tensile strength for the washed PVAm pulp is explained by the better formation originating from the washed pulp behaving more similar to the reference pulp than the unwashed. Washing will remove some of the chemicals in the water which corresponds to bad formation, but strength enhancing properties related to PVAm attached on fibers will remain.

Strength measurements results for sheets of kraft and CTMP pulp with and without PVAm are shown in the form of force-strain curves in FIGS. 5-7. When looking at the results from tensile testing of the different sheets, no significant increase in tensile stress index can be found between reference and PVAm additions (FIG. 5) even though PVAm is normally considered to be a dry-strength agent. The benefits in strength properties gained by adding PVAm is evened out by the decrease in formation. One of the pulps was washed prior to forming and had significantly higher tensile strength (Table 2). Higher tensile strength for the washed PVAm pulp compared with the unwashed is explained by the better formation originating from the washed pulp behaving more similar to the reference pulp than the unwashed. Washing will remove some of the chemicals in the water which corresponds to bad formation, but strength enhancing properties related to PVAm attached on fibers will remain.

Tables 1-3 below show mean values, standard deviation and confidence intervals for yield stress (σ_{T}^{W}), yield strain (ε_{T}), modulus of elasticity (E^{W}), and tensile energy absorption (W_{T}^{W}).

TABLE 1
Statistics from tensile measurements of 60
g/m² CTMP sheets with and without PVAm.

| | | | | |
|---|---|---|---|---|
| | σ_{T}^{w} | ε_{T} | W_{T}^{w} | E^{w} |
| Series | kNm/kg | % | J/kg | MNm/kg |

CTMP ref 60 g/m²

| | | | | |
|---|---|---|---|---|
| Mean value | 10.74 | 0.84 | 50.66 | 1.87 |
| Standard deviation | 1.42 | 0.13 | 14.24 | 0.31 |
| 95% confidence interval | 0.88 | 0.08 | 8.83 | 0.19 |

CTMP + PVAm 60 g/m²

| | | | | |
|---|---|---|---|---|
| Mean value | 11.43 | 0.89 | 57.58 | 1.78 |
| Standard deviation | 0.99 | 0.06 | 11.01 | 0.14 |
| 95% confidence interval | 0.62 | 0.04 | 6.82 | 0.09 |

TABLE 2
Statistics from tensile measurements of 200 g/m² CTMP
sheets with and without PVAm, washed and unwashed.

| | | | | |
|---|---|---|---|---|
| | σ_{T}^{w} | ε_{T} | W_{T}^{w} | E^{w} |
| Series | kNm/kg | % | J/kg | MNm/kg |

CTMP ref 200 g/m²

| | | | | |
|---|---|---|---|---|
| Mean value | 19.86 | 1.56 | 203.13 | 2.43 |
| Standard deviation | 0.86 | 0.18 | 33.94 | 0.09 |
| 95% confidence interval | 0.53 | 0.11 | 21.04 | 0.06 |

CTMP + PVAm 200 g/m² unwashed

| | | | | |
|---|---|---|---|---|
| Mean value | 16.16 | 1.08 | 102.63 | 2.18 |
| Standard deviation | 2.25 | 0.17 | 32.56 | 0.16 |
| 95% confidence interval | 1.39 | 0.11 | 20.18 | 0.10 |

CTMP + PVAm 200 g/m² washed

| | | | | |
|---|---|---|---|---|
| Mean value | 21.08 | 1.21 | 151.66 | 2.65 |
| Standard deviation | 2.33 | 0.22 | 51.62 | 0.22 |
| 95% confidence interval | 1.44 | 0.14 | 31.99 | 0.14 |

TABLE 3
Statistics from tensile measurements of 200
g/m² kraft sheets with and without PVAm.

| | | | | |
|---|---|---|---|---|
| | σ_{T}^{w} | ε_{T} | W_{T}^{w} | E^{w} |
| Series | kNm/kg | % | J/kg | MNm/kg |

Kraft 200 g/m²

| | | | | |
|---|---|---|---|---|
| Mean value | 46.33 | 2.95 | 990.22 | 4.47 |
| Standard deviation | 9.50 | 1.14 | 541.28 | 0.48 |
| 95% confidence interval | 5.89 | 0.71 | 335.48 | 0.30 |

Kraft + PVAm 200 g/m²

| | | | | |
|---|---|---|---|---|
| Mean value | 55.38 | 3.57 | 1412.07 | 4.61 |
| Standard deviation | 10.12 | 0.84 | 612.91 | 0.50 |
| 95% confidence interval | 6.27 | 0.52 | 379.88 | 0.31 |

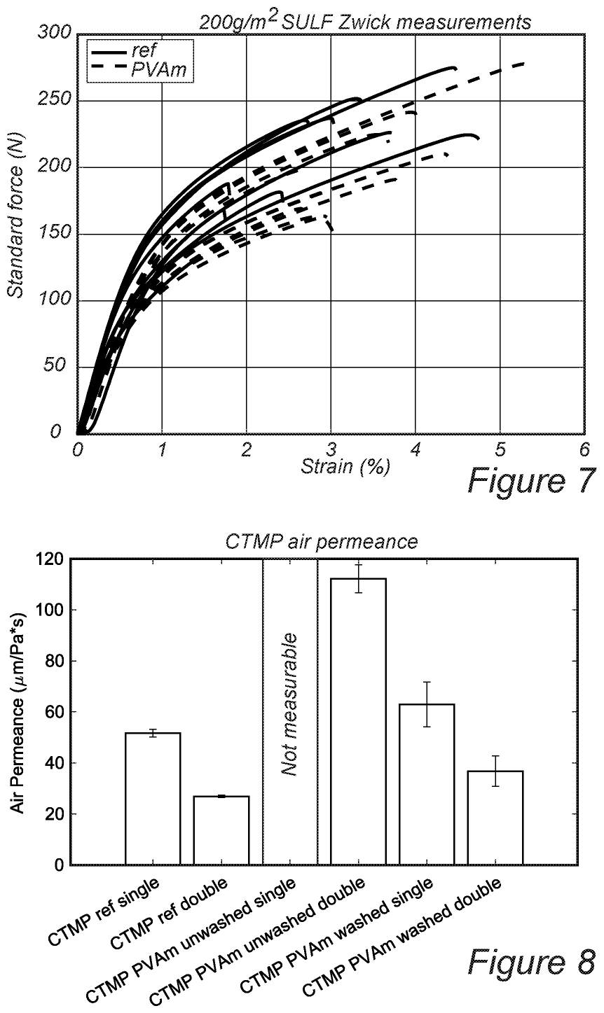

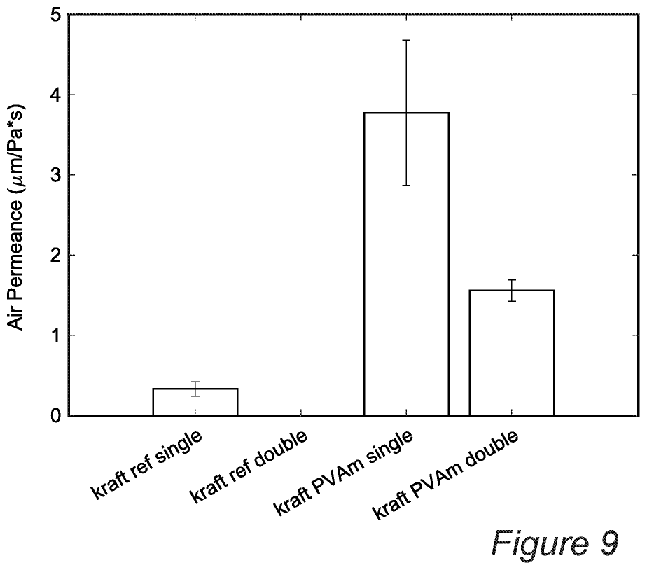

Air permeance according to Bendtsen with 0.7 kPa instead of 1.47 kPa is shown, for single and double sheets, in FIGS. 8-9. Air permeance according to Bendtsen with 0.7 kPa instead of 1.47 kPa is shown, for single and double sheets of 200 g/m² CTMP with and without 1 ml/gram fiber of PVAm (washed and unwashed). Note that CTMP PVAm unwashed single was unmeasurable because the flow in the machine was too high and the value is not 120 m/Pa*s. The error bars represent a 95% confidence interval (FIG. 8). Air permeance according to Bendtsen with 0.7 kPa instead of 1.47 kPa is shown, for single and double sheets of 200 g/m² kraft pulp with and without 1 ml/gram fiber of PVAm. Note that kraft ref double gave zero flow. The error bars represent a 95% confidence interval (FIG. 9).

Air permeance (FIGS. 8-9) give a clear result where additions of PVAm in all cases give more open sheet structures that allow more air to flow through. Higher air permeance is presumably linked with both increased flocculation allowing poorer formation of PVAm sheets compared to the reference sheets, and also bonding of fine materials to fiber surfaces. In both cases the resulting sheet would be more open for flowing air. FIG. 8 show that washed pulp gives a smaller effect on air permeance, agreeing with the observations related to formation from tensile testing where most of the chemicals in the water is removed.

Results from the fiber potential analysis of CTMP and kraft pulp are presented in Table 4 and Table 5, respectively.

TABLE 4
Statistics from Zeta potential measurements of a
suspension/stock of CTMP with and without PVAm.

| | Zeta-potential | 95% confidence |
|---|---|---|
| Cellulosic material | (mV) | interval (mV) |
| CTMP without PVAm test 1 | −86.4 | |
| CTMP without PVAm test 2 | −88.3 | |
| Mean value | −87.4 | +/−1.5 |
| CTMP with 1 wt-% PVAm test 1 | −5.9 | |
| CTMP with 1 wt-% PVAm test 2 | −5.5 | |
| Mean value | −5.7 | +/−0.3 |

The results as presented in Table 4 clearly shows that addition of PVAm to the CTMP suspension increases the Zeta potential from a mean value of −87.4 mV to a mean value of −5.7 mV, which is an increase in Zeta potential by 81.7 mV.

The measured Zeta potential values indicate that the negatively charged CTMP has become less negatively charged due to the addition of the positively charged PVAm.

TABLE 5
Statistics from Zeta potential measurements of a suspension/stock
of kraft pulp with and without PVAm.

| | Zeta-potential | 95% confidence |
|---|---|---|
| Cellulosic material | (mV) | interval (mV) |
| Kraft pulp without PVAm test 1 | −113.8 | |
| Kraft pulp without PVAm test 2 | −112 | |
| Mean value | −112.9 | +/−1.4 |
| Kraft pulp with 1 wt-% PVAm test 1 | 93.6 | |
| Kraft pulp with 1 wt-% PVAm test 2 | 89.8 | |
| Mean value | 91.7 | +/−3.0 |

The results as presented in Table 5 clearly shows that addition of PVAm to the kraft pulp suspension increases the Zeta potential from a mean value of approx. −113 mV to a mean value of approx. 92 mV, which is an increase in Zeta potential by 205 mV.

The measured Zeta potential values indicate that the negatively charged kraft pulp has become positively charged due to the addition of the positively charged PVAm.

### Measurements of Air Permeance

Due to the surprisingly findings of improved air permeance of cellulosic sheet materials produced in presence of PVAm, as presented above, additional measurements of air permeance were performed. Results are presented in Table 6.

Cellulosic sheets comprising unwashed CTMP, 100 gsm, and six different amounts of PVAm added as well as a reference cellulosic sheet with no PVAm added were tested.

TABLE 6
Air permeance measured at 125 Pa pressure on 20 m² and
expressed as Cubic Feet per Minute (CFM). All PVAm percentages
in the table are wt-% of dry weight of fibers.

| | PVAm | | | | | | |
|---|---|---|---|---|---|---|---|
| | 0% | 0.01% | 0.10% | 0.50% | 1.0% | 2.0% | 6.0% |
| CFM1 | 2.22 | 2.28 | 5.88 | 19 | 16.3 | 18 | 4.53 |
| CFM2 | 2.14 | 2.08 | 11.4 | 16.4 | 7.67 | 24 | 4.26 |
| CFM3 | 1.95 | 1.85 | 18.7 | 13.5 | 6.39 | 14.7 | 3.8 |
| MV 1-3 | 2.10 | 2.07 | 11.99 | 16.30 | 10.12 | 18.90 | 4.20 |
| STDEV | 0.14 | 0.22 | 6.43 | 2.75 | 5.39 | 4.71 | 0.37 |

Addition of a very low amount (0.01 wt-%) of PVAm seemed to have no effect on air permeance. The mean value for air permeance of CTMP sheets with 0.01 wt-% PVAm was on the same level as the air permeance of the reference CTMP sheet; 2.07 CFM and 2.10 CFM, respectively.

However, an addition of 0.1 wt-% PVAm increased the air permeance of the CTMP sheet approx. six times, i.e. with a factor of approx. six as compared to the reference sheet with no added PVAm.

The highest value of air permeance (18.90 CFM) was measured for the CTMP sheet with addition of 2.0 wt-% PVAm, i.e. a factor of nine as compared to the reference sheet.

Increasing the addition of PVAm even more, to 6.0 wt-% PVAm, resulted in a drop of air permeance. Measured air permeance was 4.20 CFM for 6.0 wt-% PVAm, which means that twice as much air flows through the CTMP sheet comprising PVAm as compared to the CTMP reference with no added PVAm, i.e. a factor of 2.

The results led to the conclusions that a concentration of PVAm of the stock is suitably greater than 0.01 wt-% in order to improve air permeance of filtering materials to be produced.

Also an even higher concentration than 6.0 wt-% PVAm will most likely improve the air permeance as compared to the CTMP reference. There may however be of no meaning to add higher concentrations of PVAm than needed to improve the air permeance of the filtering material.

The conclusions made from these experiments are the following:
Air permeance is significantly higher for sheets made from unwashed pulps with PVAm additions as the presence of PVAm probably limits a self-healing mechanism and plugging of flow channels mechanisms during dewatering. With no presence of PVAm during dewatering a self-healing mechanism occurs. Uncovered patches on the forming fabric increase the outflow of water in those locations, which in turn bring more fibers covering the holes. However, with PVAm present in the early dewatering stage addition of PVAm is suggested to limit self-healing and to maintain the increased dewatering flow that occur by poor formation and uncovered patches of the forming fabric.
Initial dewatering is faster for pulps with added PVAm, this effect is greater for CTMP and higher basis weights. The enhanced dewatering also depends on the bonding mechanism of the PVAm and its effects on self-healing and plugging of flow channels.
Strength is increased when PVAm is added but only if the pulp is washed before sheet forming. Unwashed pulp with PVAm probably give poorer formation which results in lower strengths of the sheets even if local areas could be stronger due to the presence of PVAm.
Wet-end addition of PVAm works well for both CTMP and kraft pulps with the conditions used in this study. Adding PVAm to the stock suspension in the wet-end of the paper machine has great potential for applications requiring high air permeance of the product. PVAm could also work as a dewatering enhancing agent, but caution must be taken regarding the potential of formation problems.

An example of the inventive method for producing a filtering material is now to be described.

A headbox of a paper machine is provided with an aqueous pulp suspension (also referred to as “stock”) with a consistency of 0.05-10 wt % fibers, preferably 0.1-3 wt-% fibers, and more preferred 0.1-0.3 wt-% fibers. The pulp is any of a chemi-thermomechanical pulp (CTMP), defibrated fiber-material, high temperature chemi-thermomechanical pulp (HTCTMP), chemi-mechanical pulp (CMP), stone groundwood pulp (SGW) and pressure groundwood pulp (PGW) or a mixture thereof, kraft pulp, sulphite pulp, unbleached chemical pulp, defibrated fiber material, bagasse, straws, hemp, bamboo, DIP, recycled paper and board, broke, RMP, CSP NSSC nanopulp, dissolving pulp, and regenerated fibers or mixtures thereof.

A positively charged polyelectrolyte is added to the stock.

Preferably, said polyelectrolyte is PVAm.

PVAm is added to the stock such that the concentration of PVAm in the stock is greater than 0.01 wt-% PVAm of the dry weight of cellulose fibers comprised the stock.

A preferred concentration of PVAm in the stock may be equal to or higher than 0.1 wt-% of the dry weight of cellulose fibers comprised in the stock.

Preferably, a concentration of PVAm in the stock may be equal to or higher than 0.5 wt-% of the dry weight of cellulose fibers comprised in the stock.

An even more preferred concentration of PVAm in the stock may be 0.5-2.0 wt-%.

PVAm is preferably added to the stock inside or before (upstream of) said headbox of said paper machine.

It may be preferred to adjust pH of the stock. pH of the stock may be adjusted such that the stock has a pH in the interval of pH 7 to pH 11, preferably in the interval of pH 8 to pH 10.5, and more preferred in the interval of pH 9 to pH 10. The pH adjustment is not limited to a specific acid or base but may be done by addition of any conventional acid (e.g. H₂SO₄, HCl) or base (e.g. NaOH) depending on starting pH of the stock.

It is to be understood that adjustment of pH may be performed after or before the addition of PVAm.

It may be preferred to add salt in the form of NaCl to the stock. Suitably, NaCl is added to the stock so that a concentration of NaCl IN the stock will be in the interval of 0.1-1.2 wt-% NaCl of a of weight of cellulose fibers comprised in the stock, preferably a concentration of 0.2-1.0, and more preferred a concentration of 0.3-0.8 wt-% NaCl per weight of cellulose fibers.

Addition of NaCl to the stock may take place before or after addition of PVAm.

Addition of NaCl to the stock may take place before or after adjustment of pH of the stock.

It may in some embodiments be advantageous if addition of NaCl is performed before the step of pH adjustment and that addition of PVAm is performed after the step of pH adjustment.

After the addition of PVAm to the stock and possibly addition of NaCl and pH adjustment, the headbox delivers the stock to a forming section where a forming fabric receives the stock comprising the fibers from the headbox. In the forming section dewatering occurs while the fibers simultaneously form a wet paper web.

The method preferably comprises a pressing section for further dewatering of the wet paper web by pressing. The pressing section preferably comprises at least one pressing roll.

The method preferably also comprises a drying section for drying the paper web to final dryness. Said drying section is located after/downstream of said pressing section. After said pressing section the paper web is transported to said drying section.

Said drying section may comprise hot air drying, one or several drying cylinder/-s (e.g. a Yankee cylinder), microwave and/or IR drying but other drying techniques are however conceivable.

When the paper web leaves the drying section the web has reached its final dryness.

A filtering material is produced.

In a preferred embodiment, the stock comprises HYP, preferably CTMP, of a concentration of 0.1-0.3 wt-% fibers.

NaCl is added to the stock in a headbox or at a position before (upstream of) the headbox such that the concentration of NaCl in the stock is in the interval of 0.3-0.8 wt-% NaCl of the dry weight of cellulose fibers.

After addition of NaCl, the pH is adjusted to pH 9-pH 10, preferably to pH 9.5.

PVAm is added after adjustment of pH. Preferably, PVAm is added to a concentration of 0.5-2.0 wt-% of the dry weight of cellulose fibers in the stock.

The headbox delivers the stock to a forming wire of a forming section for forming a wet web of cellulosic material. The wet web further passes a pressing section and a drying section for final drying. A filtering material has thereby been produced.

The above described embodiments are examples of web-producing procedures for manufacturing of a filtering material. However, it is conceivable that the filtering material may be produced by other papermaking wet-forming processes.

For example, the filtering material may be produced by a wet-molding procedure using a three-dimensionally (3D) shaped forming tool comprising a forming portion that is brought into contact with the pulp suspension. The pulp suspension is drawn onto the forming portion e.g. by means of vacuum suction until a fiber layer of desired thickness has been formed. The wet layer of pulp is dewatered by pressing and/or drying and a molded 3D filtering material is formed.

As will be understood by those skilled in the present field of art, numerous changes and modifications may be made to the above described and other embodiments of the present invention, without departing from the scope of the present invention as defined in the appending claims.

For example, it is conceivable that the steps of preparing the stock take place in a different order than described above. In some embodiments the polyelectrolyte may e.g. be added to the stock comprising the fibers and only thereafter, the steps of pH adjustment and salt addition are performed.

It is conceivable that more than one layer of polyelectrolyte may be adsorbed to the cellulosic material. A second layer of a negatively charged polyelectrolyte may e.g. be provided on the first layer of the positively charged polyelectrolyte. Embodiments are conceivable where there are more than two layers of charged polyelectrolytes adsorbed to the cellulosic material.

The skilled person appreciates that the invention may contemplate any fiber-based manufacturing method, including conventional wet forming procedures and dry forming procedures, wet molding procedures, dry molding procedures, three-dimensional (3D) printing techniques.

It is further conceivable that the filtering material is in the form of a solid foam.

It should be noted that the above described aspects may be the subject for its own protection, as such in a separate divisional application. Hence, it is foreseen that the aspect of improved dewatering in the forming section thanks to the addition of PVAm may require a protection by its own, e.g. since it may be applicable per se also in other concepts than that defined by the independent claims in this application.

1. A method for producing a filtering material comprising a cellulosic material and a positively charged polyelectrolyte comprising polyvinylamine (PVAm), wherein said method comprises at least the steps of:
providing a stock comprising said cellulosic material comprising cellulose fibers;
adding said polyvinylamine to said stock such that a concentration of PVAm in the stock is in an interval of 0.5-2.0 wt-% of a dry weight of cellulose fibers in the stock, and
allowing said cellulosic material to adsorb said polyvinylamine.

2. The method for producing a filtering material according to claim 1, wherein said method further comprises the following steps:
Forming a wet web of said stock comprising said cellulosic material and said polyvinylamine;
Dewatering said wet web by pressing;
Drying said wet web.

3. The method for producing a filtering material according to claim 1, wherein said method further comprises a wet-molding procedure comprising the following steps:
Providing a three-dimensionally (3D) shaped forming tool comprising a forming portion;
Bringing said 3D shaped forming tool comprising a forming portion into contact with the stock;
Apply means of vacuum suction such that the stock is drawn onto the forming portion and a 3D filtering material of desired thickness is being formed on said forming portion;
Removing said 3D filtering material from said forming portion, and
Dewatering of said 3D filtering material by pressing and/or drying, whereby a molded 3D filtering material is formed.

4. The method for producing a filtering material according to claim 1, wherein said method further comprises the step of adjusting pH of the stock to be in the interval of pH 7 to pH 11; preferably in the interval of pH 8 to pH 10.5, and more preferred in the interval of pH 9 to pH 10.

5. The method for producing a filtering material according to claim 1, wherein said method further comprises the step of adding NaCl to the stock, and to a concentration of 0.1-1.2 wt-% NaCl of a dry weight of cellulose fibers comprised in the stock, preferably a concentration of 0.2-1.0 wt-%, and more preferred a concentration of 0.3-0.8 wt-% NaCl of the dry weight of cellulose fibers.

6. The method for producing a filtering material according to claim 1, wherein NaCl is added to said stock and wherein the addition of NaCl is followed by the step of adjusting pH; after having adjusted the pH of the stock, the step of adding a polyelectrolyte to the stock is performed.

7. The method for producing a filtering material according to claim 1, wherein said cellulosic material is selected from non-wood pulps, wood pulps, mechanical pulp, refiner mechanical pulp (RMP), thermomechanical pulp (TMP), chemi-thermomechanical pulp (CTMP), defibrated fiber-material, high temperature chemi-thermomechanical pulp (HTCTMP), chemimechanical pulp (CMP), stone groundwood pulp (SGW) and pressure groundwood pulp (PGW), kraft pulp, sulphate pulp, sulphite pulp, recycled paper and board, broke, nanopulp, dissolving pulp, deinked pulp, regenerated fibers or mixtures thereof.

8. A filtering material comprising a cellulosic material and a positively charged polyelectrolyte comprising polyvinylamine (PVAm) and manufactured by a method as defined in claim 1, characterized in that said filtering material is a filtering material web, a sheet-shaped filtering material or a molded three-dimensional filtering material.

9. The filtering material according to claim 8, characterized in that said filtering material is lipophilic and hydrophobic.

10. The filtering material according to claim 8, characterized in that said cellulosic material comprises non-wood pulps, wood pulps, mechanical pulp, refiner mechanical pulp (RMP), thermomechanical pulp (TMP), chemi-thermomechanical pulp (CTMP), defibrated fiber-material, high temperature chemi-thermomechanical pulp (HTCTMP), chemimechanical pulp (CMP), stone groundwood pulp (SGW) and pressure groundwood pulp (PGW), kraft pulp, sulphate pulp, sulphite pulp, recycled paper and board, broke, nanopulp, dissolving pulp, deinked pulp, regenerated fibers or mixtures thereof.

11. The filtering material according to claim 8 characterized in that said polyelectrolyte is polyvinylamine (PVAm) selected from any of unmodified PVAm, PVAm modified with straight or branched and optionally substituted alkyl chains; preferably PVAm is unmodified.

12. The filtering material according to claim 8, characterized in that said polyelectrolyte is PVAm and said cellulosic material is HYP, preferably CTMP, and has a dry weight in an interval of 10-240 gsm.

13. A filtering system, characterized in that said filtering system comprises a filtering material as defined in claim 8.

14. A filter for use in air ventilations or face masks, characterized in that said filter comprises a filtering material as defined in claim 8.
